(19) United States
(12) Patent Application Publication
(10) Pub. No.: US 2008/0292422 A1
(43) Pub. Date: Nov. 27, 2008

(54) Self-drilling wall anchor device

(76) Inventor: Chin Hou Lin, Nantou (TW)

Correspondence Address: CHARLES E. BAXLEY, ESQUIRE, 90 JOHN STREET, SUITE 309, NEW YORK, NY, 10038, US

(21) Appl. No.: 11/805,147

(22) Filed: May 22, 2007

(51) Int. Cl. F16B 13/04

(52) U.S. Cl. 411/31

(57) ABSTRACT

A wall anchor device includes an outer anchor sleeve having an outer peripheral lip, one or more peripheral flanges extended outwardly from the middle portion for engaging with a wall member, an insert engageable into the outer anchor sleeve, and a penetrating element attached to the insert to drill the anchor sleeve into the wall and to form an aperture in the wall, the outer anchor sleeve may be expanded and engaged with the wall member, and the penetrating element includes a helical protrusion for engaging with the wall member and for evacuating a drilled or material into the aperture of the wall member and for solidly securing the wall anchor device to the wall member.

### BACKGROUND OF THE INVENTION

1. Field of the Invention

The present invention relates to a wall anchor device, and more particularly to a self-drilling wall anchor device having a discharging or evacuating device for discharging or evacuating or removing the drilled chips or dirt or materials that may be generated in the drilling operation of the wall anchor device and for preventing the wall anchor device from being interfered by the drilled chips or dirt or materials, and also for solidly securing and retaining the wall anchor device to the work pieces or the wall members.

2. Description of the Prior Art

Various kinds of typical wall anchor devices have been developed, and comprise a drilling cap or drilling head for engaging into the work pieces and for engaging a fastener into the wall members and for securing the wall anchor devices to the wall members or the like.

For example, U.S. Pat. No. 4,629,380 to Gunkel et al. discloses one of the typical wall anchor devices which comprises a mandrel portion engaged into a sleeve, and a drilling cap or drilling head attached to one end of the mandrel portion for engaging into the work pieces and for securing the wall anchor devices to the wall members or the like.

However, the drilling cap or drilling head is solidly engaged with the work pieces or the wall members or the like and may not suitably discharge or evacuate or remove the drilled chips or dirt that may be generated in the drilling operation of the wall anchor device.

U.S. Pat. No. 5,147,166 to Harker discloses a further typical wall anchor device comprising a threaded bolt threaded in an expansible body element, to expand the expansible body element and thus to engage and secure the wall anchor devices to wall members or the like, and a penetrating element attached to one end of the threaded bolt for engaging into the work pieces and for solidly securing the wall anchor devices to the wall members or the like.

However, similarly, the drilling cap or drilling head is solidly engaged with the work pieces or the wall members or the like and may not suitably discharge or evacuate or remove the drilled chips or dirt that may be generated in the drilling operation of the wall anchor device.

U.S. Pat. No. 5,690,454 to Smith discloses a still further typical wall anchor device which comprises a threaded bolt threaded or engaged in an expansible anchor member, and rotatable or drivable by a driving tool to expand the expansible anchor and thus to engage and secure the wall anchor devices to wall members or the like.

However, the drilling cap or drilling head is solidly engaged with the work pieces or the wall members or the like and may not suitably discharge or evacuate or remove the drilled chips or dirt that may be generated in the drilling operation of the wall anchor device.

The present invention has arisen to mitigate and/or obviate the afore-described disadvantages of the conventional wall anchor devices.

### SUMMARY OF THE INVENTION

The primary objective of the present invention is to provide a self-drilling wall anchor device including a discharging or evacuating device for discharging or evacuating or removing the drilled chips or dirt that may be generated in the drilling operation of the wall anchor device and for preventing the wall anchor device from being interfered by the drilled chips or dirt or materials and also for solidly securing and retaining the wall anchor device to the work pieces or the wall members.

In accordance with one aspect of the invention, there is provided a wall anchor device for engaging and anchoring into a wall member, the wall anchor device comprising an outer anchor sleeve including an outer end portion, an expandable middle portion, and an inner end portion, the outer anchor sleeve including a bore formed therein, an insert engageable into the bore of the outer anchor sleeve and including an outer end having an engaging hole formed therein for engaging with a tool device, and for allowing the insert to be rotated and driven by the tool device, the insert including an outer thread formed thereon, and including an inner end portion, a penetrating element attached to the inner end portion of the insert, to allow the penetrating element to be rotated and driven by the insert, and for drilling an aperture in the wall member, the middle portion of the outer anchor sleeve is expanded to have a decreased length relative to the outer anchor sleeve after the penetrating element and the outer anchor sleeve have been deeply engaged into the wall member, and the penetrating element includes a helical protrusion extended radially and outwardly from the penetrating element for engaging with the wall member and for evacuating a drilled chip into the aperture of the wall member and for solidly securing the wall anchor device to the wall member and also for preventing the wall anchor device from being interfered by the drilled chips or dirt or materials.

The outer anchor sleeve includes a peripheral lip extended radially and outwardly from the outer end portion of the outer anchor sleeve.

The outer anchor sleeve includes at least one peripheral flange extended outwardly therefrom for anchoring the outer anchor sleeve to the wall member. The peripheral flange of the outer anchor sleeve is preferably a helical flange.

The outer anchor sleeve includes at least one longitudinal slot formed in the middle portion thereof, to facilitate bending of the middle portion of the outer anchor sleeve.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a self-drilling wall anchor device in accordance with the present invention;

FIG. 2 is a partial cross sectional view illustrating the operation or the application of the self-drilling wall anchor device to a work piece and/or a wall member; and

FIGS. 3 and 4 are partial cross sectional views similar to FIG. 2, illustrating the operation or the application of the self-drilling wall anchor device.

### DETAILED DESCRIPTION OF THE PREFERRED EMBODIMENT

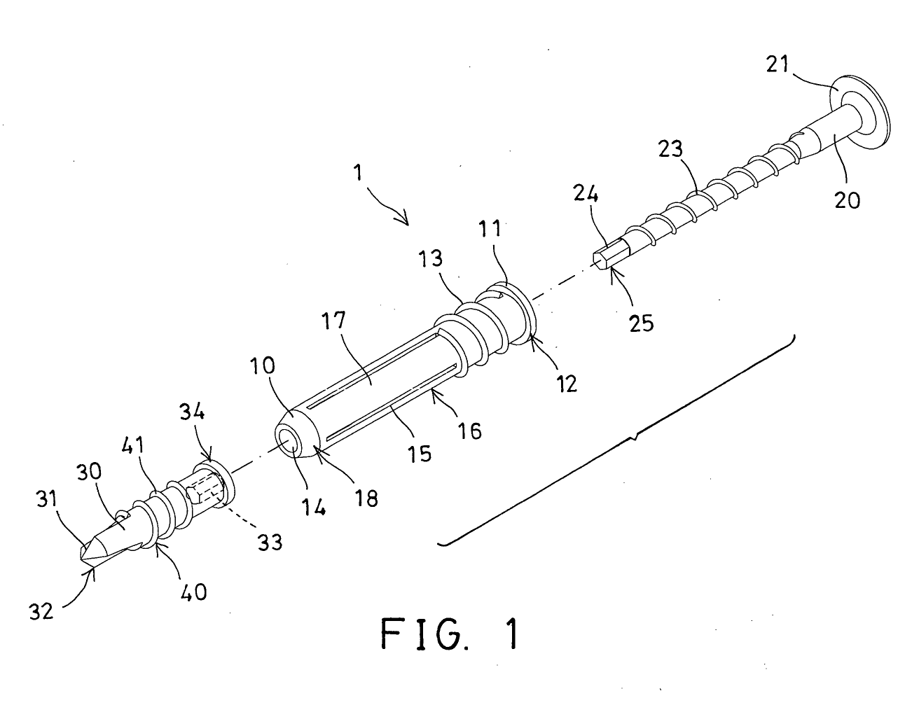

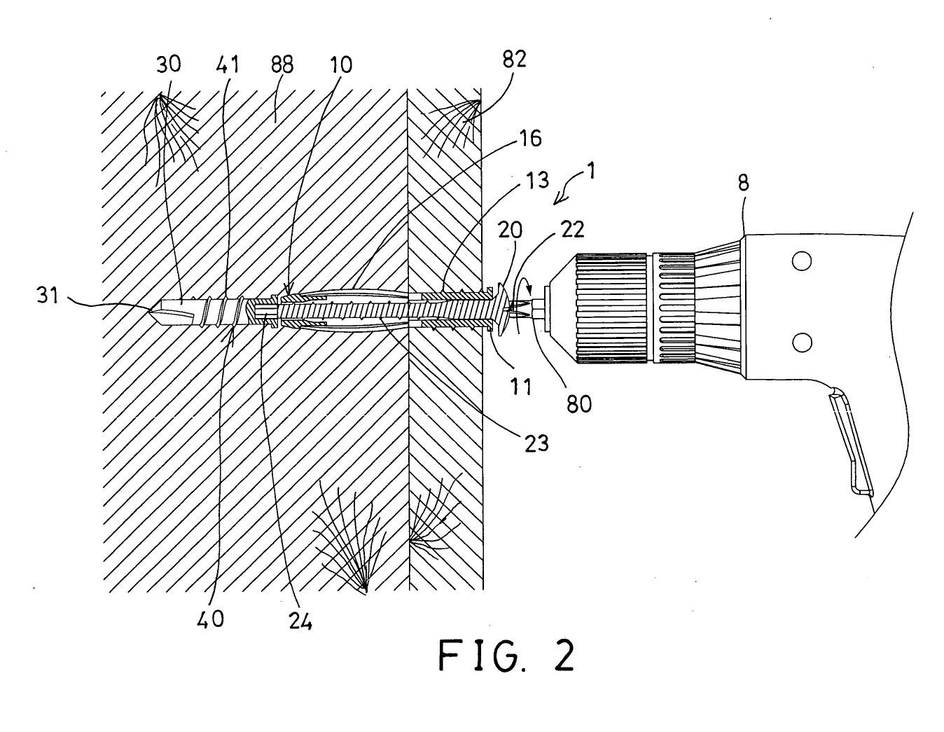

Referring to the drawings, and initially to FIGS. 1-2, a self-drilling wall anchor device 1 in accordance with the present invention is provided for being engaged with a driving tool member or driving shank 80 of a driving tool device 8 and for engaging into a work piece 82 made of such as a wood or plastic or synthetic materials, and a wall member 88 of such as a wood or plastic or concrete material, and for securing the work piece 82 to the wall member 88 or the like with the wall anchor device 1, and the self-drilling wall anchor device 1 in accordance with the present invention comprises a discharging or evacuating device 40 for discharging or evacuating or removing the drilled chips or dirt or materials that may be generated in the drilling operation of the wall anchor device 1 and for preventing the wall anchor device 1 from being interfered by the drilled chips or dirt or materials.

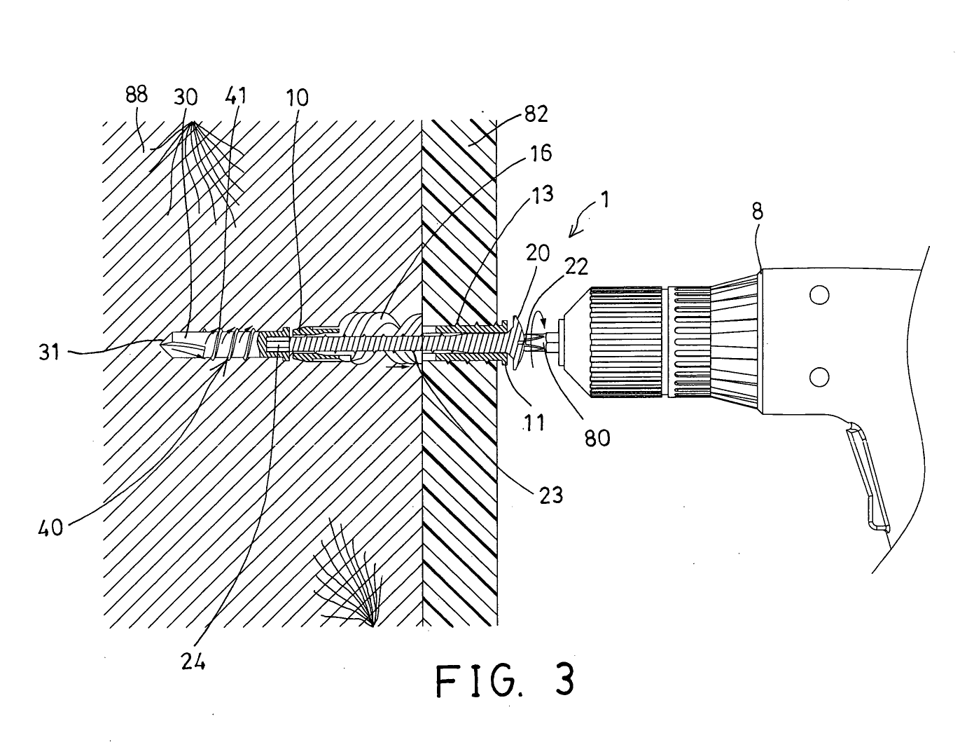

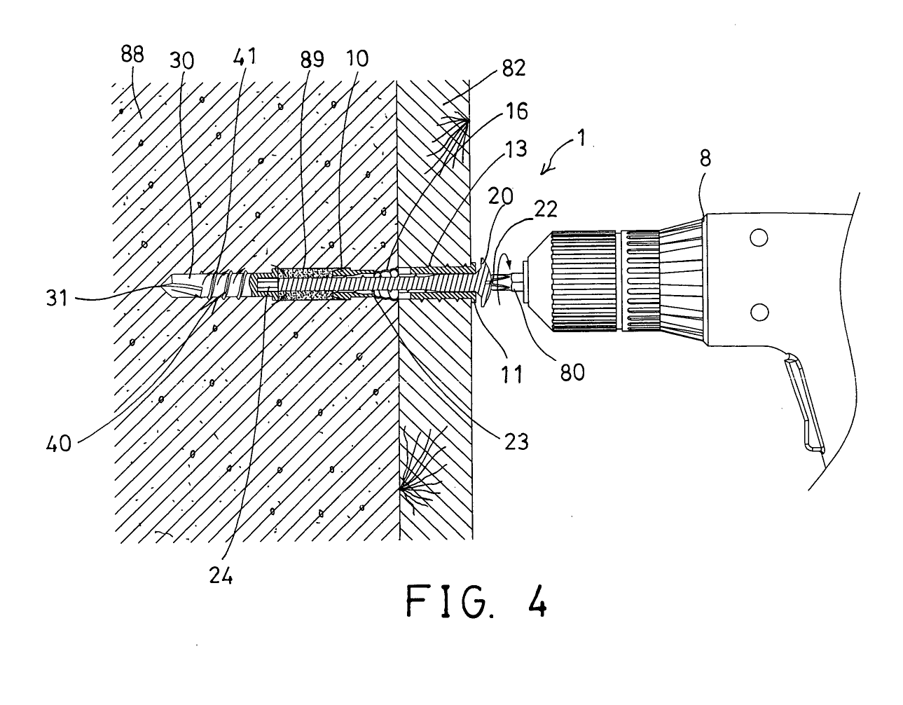

The self-drilling wall anchor device 1 in accordance with the present invention comprises an outer anchor sleeve 10 including a peripheral lip 11 extended radially and outwardly from one end or outer end 12 thereof for engaging with or for anchoring the outer anchor sleeve 10 to the work pieces 82 or the like (FIGS. 3, 4), and including one or more peripheral flanges or a helical flange 13 extended outwardly, for engaging with the work pieces 82 and for allowing the outer anchor sleeve 10 of the self-drilling wall anchor device 1 to be solidly secured to the work pieces 82. The outer anchor sleeve 10 includes a bore 14 formed therein, and one or more longitudinal slots 15 formed in a middle portion 16 thereof, and also communicating with the bore 13 thereof, for forming one or more resilient or foldable blade 17 and for allowing the middle portion 16 of the outer anchor sleeve 10 to be easily bent or expanded than the outer end portion 12 and the inner end portion 18 of the outer anchor sleeve 10.

The self-drilling wall anchor device 1 includes an insert 20 engageable into the bore 14 of the outer anchor sleeve 10, and having an enlarged head 21 formed or provided on one end or outer end thereof and having a non-circular engaging hole 22 formed in the enlarged head 21 (FIGS. 2-4), for receiving the driving shank 80 of the driving tool 8, and for allowing the insert 20 to be rotated or driven by the driving shank 80 of the driving tool 8 or other driving tools (not shown). The insert 20 includes an outer thread 23 formed in the middle portion thereof for engaging with the outer anchor sleeve 10, and a driving stem 24 formed or provided in the other end or the inner end portion 25 thereof and having a non-circular cross section, for engaging with the drill head or penetrating element 30 (FIGS. 2-4), and for anchoring or attaching or securing the insert 20 to the penetrating element 30, and thus for allowing the penetrating element 30 to be rotated or driven by the insert 20. The penetrating element 30 may also be solidly secured to the insert 20 by such as welding processes or the like.

The penetrating element 30 includes a drilling portion 31 from one end or inner end 32 thereof for engaging into the work piece 82 and the wall member 88 and for drilling into the work piece 82 and the wall member 88 (FIGS. 2-4), and includes an orifice 33 formed in the other end or outer end 34 thereof and also having a non-circular cross section, for engaging with or for receiving the corresponding non-circular driving stem 24 and thus for allowing the penetrating element 30 to be rotated or driven by the insert 20. The discharging or evacuating means or device 40 is provided for discharging or evacuating or removing the drilled chips or dirt or materials that may be generated in the drilling operation of the wall anchor device 1 and for preventing the wall anchor device 1 from being interfered by the drilled chips or dirt or materials.

For example, the discharging or evacuating means or device 40 includes a helical protrusion 41 extended radially and outwardly from the penetrating element 30 for engaging with the work piece 82 and/or the wall member 88 and for discharging or evacuating or removing the drilled chips or dirt or materials into the drilled aperture 89 of the wall member 88 (FIG. 4) that has been drilled or formed by the wall anchor device 1, and thus for allowing the wall anchor device 1 to be solidly secured to the work pieces 82 and/or the wall members 88.

In operation, as shown in FIGS. 2-4, the penetrating element 30 may be engaged into or through the work piece 82 and the wall member 88 and may form a cavity 89 in the wall member 88 and/or the work piece 82. After the penetrating element 30 is engaged through or into the work piece 82 and the wall member 88 or deeply into the work piece 82 and the wall member 88 by the driving shank 80 of the driving tool 8, the peripheral lip 11 of the outer anchor sleeve 10 may be engaged with or anchored to the work piece 82 or the like to prevent the outer anchor sleeve 10 from deeply engaged into the work piece 82. When the penetrating element 30 is further rotated or driven by the driving shank 80 of the driving tool 8, the outer anchor sleeve 10 may no longer be engaged into the work piece 82 and the wall member 88, and the insert 20 may be forced to rotate relative to the outer anchor sleeve 10, and to expand (FIG. 2) or to twist (FIGS. 3, 4) the thinner or expandable middle portion 16 of the outer anchor sleeve 10, and to allow the middle portion 16 of the outer anchor sleeve 10 to be easily bent or expanded or twisted to have a decreased length relative to the outer and the inner end portions 12, 18 of the outer anchor sleeve 10.

The peripheral flanges or the helical flange 13 of the outer anchor sleeve 10 may further be forced to engage into the work piece 82 and the wall member 88 to allow the outer anchor sleeve 10 of the self-drilling wall anchor device 1 to be solidly secured to the work piece 82 and the wall member 88 or the like and to be prevented from being disengaged from the work piece 82 and the wall member 88. When the middle portion 16 of the outer anchor sleeve 10 is expanded or twisted, the helical protrusion 41 may be engaged with the work piece 82 and/or the wall member 88 for discharging or evacuating or removing the drilled chips or dirt or materials into the drilled aperture 89 (FIG. 4) that has been drilled or formed by the wall anchor device 1 after the middle portion 16 of the outer anchor sleeve 10 has been expanded and twisted to have a decreased length, such that the expanded and twisted or shortened middle portion 16 of the outer anchor sleeve 10 may further be solidly secured and retained to the work piece 82 and/or the wall member 88.

Accordingly, the self-drilling wall anchor device in accordance with the present invention includes a discharging or evacuating device for discharging or evacuating or removing the drilled chips or dirt or materials that may be generated in the drilling operation of the wall anchor device and for preventing the wall anchor device from being interfered by the drilled chips or dirt and also for solidly securing and retaining the wall anchor device to the work pieces or the wall members.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A wall anchor device for engaging and anchoring into a wall member, said wall anchor device comprising:
an outer anchor sleeve including an outer end portion, an expandable middle portion, and an inner end portion, said outer anchor sleeve including a bore formed therein,
an insert engageable into said bore of said outer anchor sleeve and including an outer end having an engaging hole formed therein for engaging with a tool device, and for allowing said insert to be rotated and driven by the tool device, said insert including an outer thread formed thereon, and including an inner end portion,
a penetrating element attached to said inner end portion of said insert, to allow said penetrating element to be rotated and driven by said insert, and for drilling an aperture in the wall member,
said middle portion of said outer anchor sleeve being expanded to have a decreased length relative to said outer anchor sleeve after said penetrating element and said outer anchor sleeve have been deeply engaged into the wall member, and
said penetrating element including a helical protrusion extended radially and outwardly from said penetrating element for engaging with the wall member and for evacuating drilled or materials into said aperture of the wall member and for solidly securing said wall anchor device to the wall member.

2. The wall anchor device as claimed in claim 1, wherein said outer anchor sleeve includes a peripheral lip extended radially and outwardly from said outer end portion of said outer anchor sleeve.

3. The wall anchor device as claimed in claim 1, wherein said outer anchor sleeve includes at least one peripheral flange extended outwardly therefrom for anchoring said outer anchor sleeve to the wall member.

4. The wall anchor device as claimed in claim 3, wherein said at least one peripheral flange of said outer anchor sleeve is a helical flange.

5. The wall anchor device as claimed in claim 1, wherein said outer anchor sleeve includes at least one longitudinal slot formed in said middle portion thereof, to facilitate bending of said middle portion of said outer anchor sleeve.
